(19) United States
(12) Patent Application Publication
(10) Pub. No.: US 2026/0326866 A1
(43) Pub. Date: Oct. 22, 2026

(54) Subsea Infrastructure Inspection & Protection System

(71) Applicant: Oceaneering International, Inc., Houston, TX (US)

(72) Inventor: Kenneth SOLBØR, SANDNES (NO)

(73) Assignee: Oceaneering International, Inc., Houston, TX (US)

(21) Appl. No.: 19/305,960

(22) Filed: Aug. 21, 2025

Related U.S. Application Data
(60) Provisional application No. 63/685,631, filed on Aug. 21, 2024.

(51) Int. Cl. B63C 11/52; F17D 5/06; G05D 1/226; G05D 1/229; G05D 107/00; G05D 109/30

(52) U.S. Cl. CPC B63C 11/52; F17D 5/06; G05D 1/226; G05D 1/2295; G05D 2107/27; G05D 2109/38

(57) ABSTRACT

Subsea infrastructure inspection and protection system 1, comprising one or more dispatchable drones 20 operating within one or more geo-fenced areas 10 and system processor 40, may be used by setting up monitoring in a predetermined geo-fenced area 10 using obtaining data from one or more dispatchable drones 20 and sensor net 30; combining the data obtained from sensor net 30 with data obtained from dispatchable drone 20 over a predetermined time span such as via system processor 40; using machine learning module 42 and artificial intelligence module 43 to process the combined data in such a way as to identify and analyze an event occurring within, or an intrusion into, geo-fenced area 10 based on the processed combined data; and performing a predetermined set of functions bused on the identified and analyzed event.

### CROSS-REFERENCE TO RELATED APPLICATIONS

This application claims priority through U.S. Provisional Application 63/685,631 filed on Aug. 21, 2024 and incorporates U.S. Provisional Application 63/685,631 by reference.

### BACKGROUND OF THE INVENTION

Subsea environments have a need to have the environments inspected and protected such as for security, environmental, asset integrity inspection, and intervention arising from events and intrusions in or near that environment, e.g., an oil leak arising from a pipeline or ground-origin, entry of a known or unknown surface vessel, entry of a known or unknown submarine vehicle, entry of a cetacean, and the like. This need can encompass detection and monitoring as well as allowing for responses to intrusions.

### BRIEF DESCRIPTION OF DRAWINGS

Various figures are included herein which illustrate aspects of embodiments of the disclosed inventions.

FIG. 1 is a block diagram of an exemplary system;

FIG. 2 is a further block diagram of an exemplary system; and

FIG. 3 is a further block diagram of an exemplary system.

### DETAILED DESCRIPTION OF EMBODIMENTS OF THE INVENTION

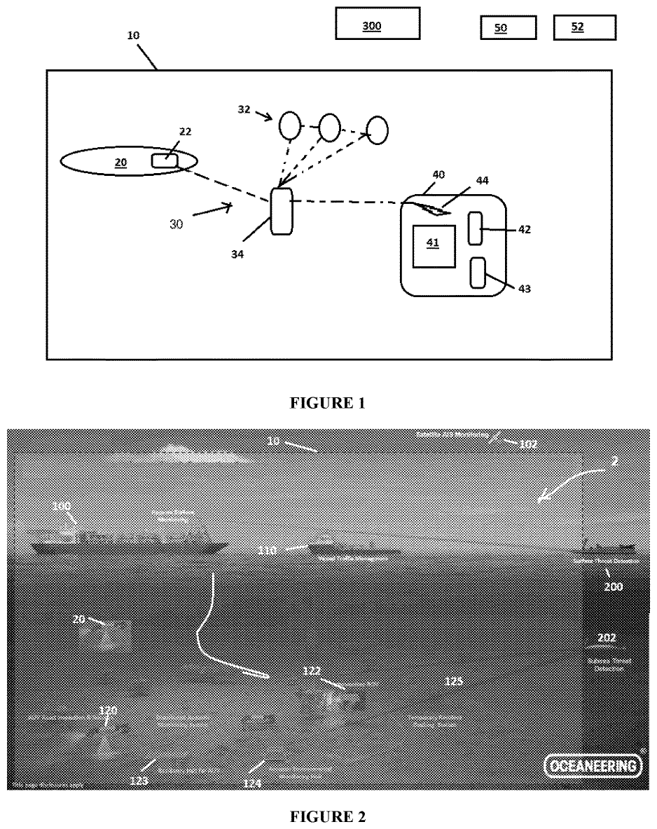

In a first embodiment, referring generally to FIG. 1, subsea infrastructure inspection and protection system 1 comprises one or more geo-fenced areas 10; one or more dispatchable drones 20, at least one dispatchable drone 20 comprising drone data communicator 22; sensor net 30, comprising a predetermined set of networked sensors 32 configured to provide a predetermined set of data and sensor data communicator 34 operatively in communication with at least one networked sensor 32 of the predetermined set of networked sensors 32 and adapted to interface with at least one dispatchable drone 20 via its drone data communicator 22; and system processor 40 operatively in communication with the predetermined set of networked sensors 32.

Geo-fenced area 10 typically comprises subsea location 2, e.g., a worksite or other area, and may further extend to a surface location, e.g., one proximate the subsea location.

Dispatchable drone 20 may comprise autonomous underwater vehicle (AUV) 21 which may further comprise a multibeam echosounder (MBES); an optical device such as a laser or camera or the like, or a combination thereof; a cathodic protector (CP); an environmental sensor such a conductivity, temperature, and depth sensor, a turbidity sensor, a fluorometer, or the like, or a combination thereof; a leak detection sensor, such as a hydrocarbon sensor, a multibeam echosounder (MBES), a fluorescence leakage sensor (FLS), methane sensor (MAS), or the like, or a combination thereof; an oil spill response tool such as one comprising a downward camera, a forward camera, or the like, or a combination thereof; or the like or a combination thereof. AUV 21 may be an underwater intervention drone adapted to remain operational for a long period of time, e.g., up to or exceeding twenty-four hours a day, seven days a week, and to provide data regarding routine and event patrolling subsea. Drone data communicator 22 and sensor data communicator 34 may comprise a complementary set of wireless data communicators such as acoustic data communicators.

Predetermined set of networked sensors 32, typically configured to provide a predetermined set of data related to a predetermined set of functions, are typically disposed within or at least partially within geo-fenced area 10. The predetermined set of functions typically comprise one or more of security, environmental, asset integrity inspection, and intervention functions including, but not limited to, intrusion identification of one or more objections which have become present in geo-fenced area 10.

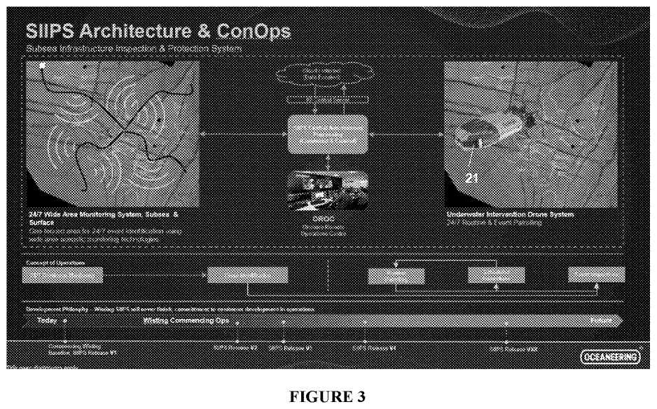

System processor 40 is operative to identify and analyze one or more events within or near, and/or intrusions into, geo-fenced area 10 and to issue a predetermined set of commands to a vehicle such as a remotely operated vehicle (ROV) 122 (FIG. 2), AUV 21, or the like, or a combination thereof. System processor 40 typically comprises one or more central processing systems 41 adapted to issue one or more commands to control a predetermined set of functions such as subsea infrastructure inspection and subsea infrastructure protection or the like or a combination thereof. System processor 40 typically further comprises a predetermined set of machine learning models 42 and a predetermined set of artificial intelligence modules 43, each accessible to and operative within central processing system 41. As will be familiar to those of ordinary skill in data processing arts, central processing systems 41 typically comprise a central processing unit and memory store and the predetermined set of machine learning models 42 and predetermined set of artificial intelligence modules 43 typically comprise executable computer instructions stored within that memory store. Central processing system 41 may further comprise an autonomous command and control system.

In embodiments, system processor 40 also comprises system processor data communicator 44 configured to receive data from sensor net 30 where the system processor data communicator 44 may comprise a wireless data communicator.

In embodiments, system processor data communicator 44 is further configured to be in data communication with remote operations center 50 which may be onshore or offshore, central input/output (I/O) server 52 which can further provide data communications with systems such as via the cloud, Internet communication link 102 (FIG. 2), or the like, or a combination thereof.

In embodiments, referring additionally to FIG. 2, subsea infrastructure inspection and protection system 1 further comprises one or more remote surface monitors 300 (FIG. 1); one or more surface threat detectors 200 operatively in data communication with at least one remote surface monitor 300; one or more vessel traffic managers 110; one or more AUV asset inspection and survey systems 120; a predetermined set of distributed acoustic monitors, typically disposed subsea; a predetermined set of residency hubs 123 disposed subsea and adapted to interface with the automated underwater vehicle asset inspection and survey system 120; a predetermined set of acoustic environmental monitoring hubs 124; a predetermined set of ROVs 122; a predetermined set of temporary resident docking stations 125 disposed subsea and adapted to interface with ROV 122 and/or AUV 21 120; and one or more subsea threat detection systems 202 disposed subsea and operatively in communication with ROV 122 and acoustic environmental monitoring hub 124.

In the operation of exemplary methods, referring back to FIGS. 1 and 2, subsea infrastructure inspection and protection system 1, as described above, may be used by setting up monitoring in a predetermined geo-fenced area 10 using obtaining data from one or more dispatchable drones 20 and sensor net 30; combining the data obtained from sensor net 30 with data obtained from dispatchable drone 20 over a predetermined time span such as via system processor 40; using machine learning module 42 and artificial intelligence module 43 to process the combined data in such a way as to identify and analyze an event occurring within, or an intrusion into, geo-fenced area 10 based on the processed combined data; and performing a predetermined set of functions bused on the identified and analyzed event. The predetermined time span may comprise a time span of twenty-four hours a day, seven days a week.

Processing the combined data typically comprises fusing sensor data from the predetermined set of networked sensors 30 into a single data set and using the predetermined set of machine learning models 42 to review the single data set when identifying the event or intrusion. In embodiments, the event or intrusion comprises an oil leak, an entry of a surface vessel into the geo-fenced area, an entry of a submerged vessel into the geo-fenced area, an entry of an animal into the geo-fenced area, or the like, or a combination thereof.

In embodiments, performing the predetermined set of functions occurs while maintaining regulatory compliance and protecting a predetermined set of assets, e.g., assets at or above a predetermined value level. In embodiments, the predetermined set of functions comprises monitoring a leak such as an oil and/or gas leak from a subsea structure, e.g., a pipeline or other structure; safeguarding an environment; enhancing operational safety within geo-fenced area 10; providing a rapid response based on intrusion into geo-fenced area 10; providing comprehensive detection of a predetermined set of events, e.g., which can enable detection of both pipeline and ground-origin leaks; providing a holistic monitoring solution; providing enhanced environmental protection which can minimize environmental impact by promptly identifying and addressing leaks from any source; improving safety to help ensure the safety of operations by providing real-time data and alerts for leaks and intrusion; providing enhanced security and protection by aiding identification of intrusion of unknown assets near the field and rapid follow-up at detection location; or the like, or a combination thereof.

In embodiments, vehicle patrolling and inspection may occur in a continuous loop as part of, or complimentary to, monitoring, typically but not exclusively autonomously.

In embodiments, logging the identified event or intrusion may also occur and logged data captured and used to aid in subsequent prediction of events and intrusions.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1) A subsea infrastructure inspection and protection system, comprising:
a) a geo-fenced area;
b) a dispatchable drone comprising a drone data communicator;
c) a sensor net, comprising:
i) a predetermined set of networked sensors configured to provide related to a predetermined set of data related to a predetermined set of functions, the predetermined set of networked sensors disposed within the geo-fenced area for intrusion identification; and
ii) a sensor data communicator operatively in communication with the predetermined set of networked sensors and adapted to interface with the dispatchable drone via the drone data communicator; and
d) a system processor operatively in communication with the predetermined set of networked sensors, the system processor operative to identify and analyze an event and to issue a predetermined set of commands to a vehicle, the system processor comprising:
i) a central processing system adapted to issue a command to control a predetermined set of functions, the predetermined set of functions comprising subsea infrastructure inspection and subsea infrastructure protection;
ii) a predetermined set of machine learning models accessible to and operative within the central processing system; and
iii) a predetermined set of artificial intelligence modules accessible to and operative within the central processing system.

2) The subsea infrastructure inspection and protection system of claim 1, wherein the geo-fenced area comprises a subsea location.

3) The subsea infrastructure inspection and protection system of claim 1, wherein the system processor comprises a system processor data communicator configured to receive data from the sensor net.

4) The subsea infrastructure inspection and protection system of claim 3, wherein the system processor data communicator comprises a wireless data communicator.

5) The subsea infrastructure inspection and protection system of claim 3, wherein the system processor data communicator is further configured to be in data communication with a remote operations center or a central input/output (I/O) server.

6) The subsea infrastructure inspection and protection system of claim 1, wherein the central processing system further comprises an autonomous command and control system.

7) The subsea infrastructure inspection and protection system of claim 1, wherein the dispatchable drone comprises an autonomous underwater vehicle (AUV 21), comprising:
a) a multibeam echosounder (MBES);
b) an optical device;
c) a cathodic protector;
d) an environmental sensor;
e) a leak detection sensor; and
f) an oil spill response tool.

8) The subsea infrastructure inspection and protection system of claim 7, wherein the dispatchable drone comprises an underwater intervention drone adapted to remain operational for a predetermined length of time and provide data regarding routine and event patrolling subsea.

9) The subsea infrastructure inspection and protection system of claim 1, further comprising:
a) a remote surface monitor;
b) a surface threat detector operatively in data communication with the remote surface monitor;
c) a vessel traffic manager;
d) an automated underwater vehicle (AUV 21) asset inspection and survey system;
e) a predetermined set of distributed acoustic monitors;
f) a predetermined set of residency hubs disposed subsea and adapted to interface with the automated underwater vehicle asset inspection and survey system;
g) a predetermined set of acoustic environmental monitoring hubs;
h) a predetermined set of remotely operated vehicles (ROV);
i) a predetermined set of temporary resident docking stations disposed subsea and adapted to interface with an ROV and/or an AUV 21; and
j) a subsea threat detection system disposed subsea and operatively in communication with the ROV and an acoustic environmental monitoring hub of the predetermined set of acoustic environmental monitoring hubs.

10) The subsea infrastructure inspection and protection system of claim 1, wherein the drone data communicator and the sensor data communicator further comprise a complementary set of wireless data communicators.

11) The subsea infrastructure inspection and protection system of claim 10, wherein the complementary set of wireless data communicator comprises an acoustic data communicator.

12) The subsea infrastructure inspection and protection system of claim 1, wherein the predetermined set of functions comprise security, environmental, asset integrity inspection, and intervention.

13) A method for using a subsea infrastructure inspection and protection system comprising a geo-fenced area; a dispatchable drone comprising a drone data communicator; a sensor net, comprising a predetermined set of networked sensors configured to provide related to a predetermined set of data related to a predetermined set of functions, where the predetermined set of networked sensors are disposed within the geo-fenced area for intrusion identification, and a sensor data communicator operatively in communication with the predetermined set of networked sensors and adapted to interface with the dispatchable drone via the drone data communicator; and a system processor operatively in communication with the predetermined set of networked sensors, the system processor operative to identify and analyze an event and to issue a predetermined set of commands to a vehicle, the system processor comprising a central processing system adapted to issue a command to control a predetermined set of functions where the predetermined set of functions comprise subsea infrastructure inspection and subsea infrastructure protection, a predetermined set of machine learning models accessible to and operative within the central processing system, and a predetermined set of artificial intelligence modules accessible to and operative within the central processing system, the method comprising:
a) setting up monitoring in the geo-fenced area by obtaining data from the dispatchable drone and the sensor net;
b) combining the data obtained from the sensor net with the data obtained from the dispatchable drone over a predetermined time span into a combined data set;
c) using the predetermined set of machine learning modules and the predetermined set of artificial intelligence modules to:
i) process the combined data set; and
ii) identify and analyze an event within or an intrusion into the geo-fenced area based on the processed combined data; and
d) performing a predetermined set of functions bused on the identified and analyzed event.

14) The method of claim 13, wherein the predetermined time span comprises twenty-four hours a day, seven days a week.

15) The method of claim 13, wherein performing the predetermined set of functions occurs while maintaining regulatory compliance and protecting a predetermined set of assets.

16) The method of claim 13, wherein the predetermined set of functions comprises:
a) monitoring a leak;
b) safeguarding an environment;
c) enhancing operational safety;
d) rapid response of intrusion into the geo-fenced area;
e) providing comprehensive detection which can enable detection of both pipeline and ground-origin leaks;
f) providing a holistic monitoring solution;
g) enhanced environmental protection which can minimize environmental impact by promptly identifying and addressing leaks from any source;
h) improved safety to help ensure operations safety by providing real-time data and alerts for leaks and intrusion; and
i) security and protection by aiding identification of intrusion of unknown assets near or within the geo-fenced area and provide for rapid follow-up at detection location.

17) The method of claim 16, further comprising using a continuous loop of vehicle patrolling and inspection as part of, or complimentary to, monitoring.

18) The method of claim 13, wherein processing the processed combined data set comprises:
a) fusing sensor data from the predetermined set of networked sensors into a single data set; and
b) using the predetermined set of machine learning models to review the single data set when identifying the event or intrusion.

19) The method of claim 18, wherein the event or intrusion comprises an oil leak, an entry of a surface vessel into the geo-fenced area, an entry of a submerged vessel into the geo-fenced area, an entry of an animal into the geo-fenced area.

20) The method of claim 13, further comprising:
a) logging the identified event or intrusion; and
b) using logged data to aid in subsequent prediction of events and intrusions.
